(19) United States
(12) Patent Application Publication
(10) Pub. No.: US 2002/0097229 A1
(43) Pub. Date: Jul. 25, 2002

(54) Game and home entertainment device remote control

(75) Inventors: Eric P. Rose, Tarzana, CA (US); Jack A. Segal, Oxnard, CA (US); William A. Yates, Camarillo, CA (US)

Correspondence Address: Mark D. Chuey, Brooks & Kushman P.C., 1000 Town Center, 22nd Floor, Southfield, MI, 48075-1351, US

(73) Assignee: Interlink Electronics, Inc., Camarillo, CA

(21) Appl. No.: 10/057,266

(22) Filed: Jan. 24, 2002

Related U.S. Application Data
(60) Provisional application No. 60/263,819, filed on Jan. 24, 2001.

(51) Int. Cl. G09G 5/00

(52) U.S. Cl. 345/173

(57) ABSTRACT

Home entertainment devices may be controlled and on-screen games played with a single controller. At least one gesture by a user is made on a touch pad. If the gesture was made for controlling the home entertainment device, at least one control signal is generated for the home entertainment device based on the gesture. If the gesture was made for playing a game, a game activity based on the gesture is performed and the results displayed on a display screen.

### CROSS-REFERENCE TO RELATED APPLICATIONS

This application claims the benefit of U.S. provisional application Serial No. 60/263,819 filed Jan. 24, 2001 which is herein incorporated by reference in its entirety.

### BACKGROUND OF THE INVENTION

1. Field of the Invention

The present invention generally relates to remote controls for controlling home entertainment devices and controls for playing on-screen games.

2. Background Art

Remote controls for home entertainment (HE) devices offer the ability to control HE devices remotely. Many people find HE remote controls intimidating and difficult to use because control operation is based on a button-centric paradigm that typically contain more buttons than can be easily managed. This crowded geography causes considerable confusion and intimidation and makes finding the desired button difficult. Further, HE remote controls are often used in a dark room where reading button legends is difficult due to the crowded HE remote control layout.

Normal home entertainment viewing takes place at a distance of three meters or more and the display being viewed is usually quite large such as a TV having a diagonal viewing surface typically falling between about 60 cm and 184 cm. The legends on HE remote controls are usually twelve point type or smaller. For many operators, changing viewing distance requires changing glasses or putting on reading glasses.

Enhanced TV and related applications require the extensive use of graphic user interfaces (GUI) and on-screen displays or menus. Enhanced TV typically includes a television and support equipment configured for one or more of cable video programming, Internet browsing, Internet telephony, video cassette recording, stereo receiving, and the like. The operator typically navigates through various menus to select enhanced TV options. However, using up, down, right and left arrow keys to navigate these menus is difficult, slow, and frustrating. The increasing number of television channels has given rise to the electronic program guide (EPG). Because an EPG is a dense grid of selections, using arrow keys to navigate is even more difficult.

Interactive television often requires text entry. The current solution, a wireless keyboard, is undesirable in a typical viewing area, such as a living room, for a variety of reasons including the keyboard not fitting the decor of the viewing area, a lack of appropriate space to set the keyboard for typing, and a refusal to have computer related equipment in the viewing area. In addition, many people associate typing with work and have no desire to place a keyboard in a room devoted to entertainment.

Many HE systems are assembled by their owners over a period of time from a variety of sources. Typically, each component has its own remote control. The result is separate remote controls for the TV, stereo, cable box, telephone, video tape player or disk players, audio tape or disc player, and the like. In addition to creating clutter, the proliferation of remote controls generates confusion and frustration.

Televisions are also used to play various on-screen games. Traditionally, playing on-screen games require a specialized electronics system, or game console, that provides at least video input to the TV. One or more input devices, such as joysticks, track balls, game controllers with a plurality of buttons, and the like, provide input for game playing. Often, each input device requires learning new hand movements. Further, this equipment adds to clutter in the viewing area.

### SUMMARY OF THE INVENTION

Many of these problems can be reduced or eliminated through the use of a remote control having a touch pad that recognizes gestures performed on the touch pad for controlling one or more HE devices as well as on-screen games. The remote control touch pad operates with a display screen, such as is found on a television, for displaying a gesture performed on the touch pad or for displaying the results of the gesture.

Various modes of operation are possible. The display screen may be mapped to the touch pad so that a gesture performed on the touch pad surface area is scaled correspondingly on to an appropriate region of the display screen. The display screen may be provided with a movable object such that, in response to an operator touching the touch pad, the movable object is moved to the location of the display screen corresponding to the location of the touch on the touch pad. The touch pad area may be logically divided into a plurality of regions, each region corresponding to one of a plurality of selectable screen items. The touch pad may be divided into regions such that a gesture in one region results in a different action than the same gesture in another region. Due to its flexibility, the functioning of the touch pad may vary between games; may vary between scenarios within the same game; may be programmable by the operator; may adapt to operator idiosyncrasies such as left- or right-handedness, preferred use of thumb, forefinger or stylus, typical force applied; and the like.

In one embodiment, the remote control includes a touch pad having a surface area on which an operator touches to perform a gesture. The touch pad generates a signal indicative of the gesture performed on the touch pad surface area. Each gesture performed on the touch pad surface area corresponds to a home entertainment device or on-screen game control function. A controller is operable with the touch pad for receiving the signal and enabling one or more control functions corresponding to the gesture performed on the touch pad surface area.

The present invention also provides a remote control for controlling a home entertainment device or on-screen games using a display screen provided with at least one movable object. The touch pad is operable with the display screen such that the display screen is mapped to the touch pad surface area. The touch pad generates a signal indicative of the location of the touch on the touch pad surface area. A controller receives the touch pad signal and moves the movable object on the display screen to the location on the display screen corresponding to the location of the touch on the touch pad surface area.

### BRIEF DESCRIPTION OF THE DRAWINGS

FIG. 1 shows a block diagram of a remote control for controlling a home entertainment device or for playing games in accordance with an embodiment of the present invention;

FIG. 2 shows a table of home entertainment device control functions according to embodiments of the present invention;

FIG. 3 shows a perspective view of a remote control for controlling home entertainment devices or for playing games in accordance with an embodiment of the present invention;

FIG. 4 shows an electronic program guide displayed on a display screen according to an embodiment of the present invention;

FIG. 5 shows a menu listing control functions or menu options for a home entertainment device according to an embodiment of the present invention;

FIG. 6 shows a keyboard having alphanumeric keys for controlling a home entertainment device or on-screen game according to an embodiment of the present invention;

FIG. 7 shows a table listing various game types according to embodiments of the present invention;

FIG. 8 shows a poker game example according to an embodiment of the present invention;

FIG. 9 shows a illustration of dividing a touch pad and into regions having different control functions according to an embodiment of the present invention;

FIG. 10 shows a touch pad combining both regional gestures and global gestures according to an embodiment of the present invention; and

FIGS. 11-16 show views of a remote control according to an embodiment of the present invention.

### DETAIL DESCRIPTION OF THE PREFERRED EMBODIMENT(S)

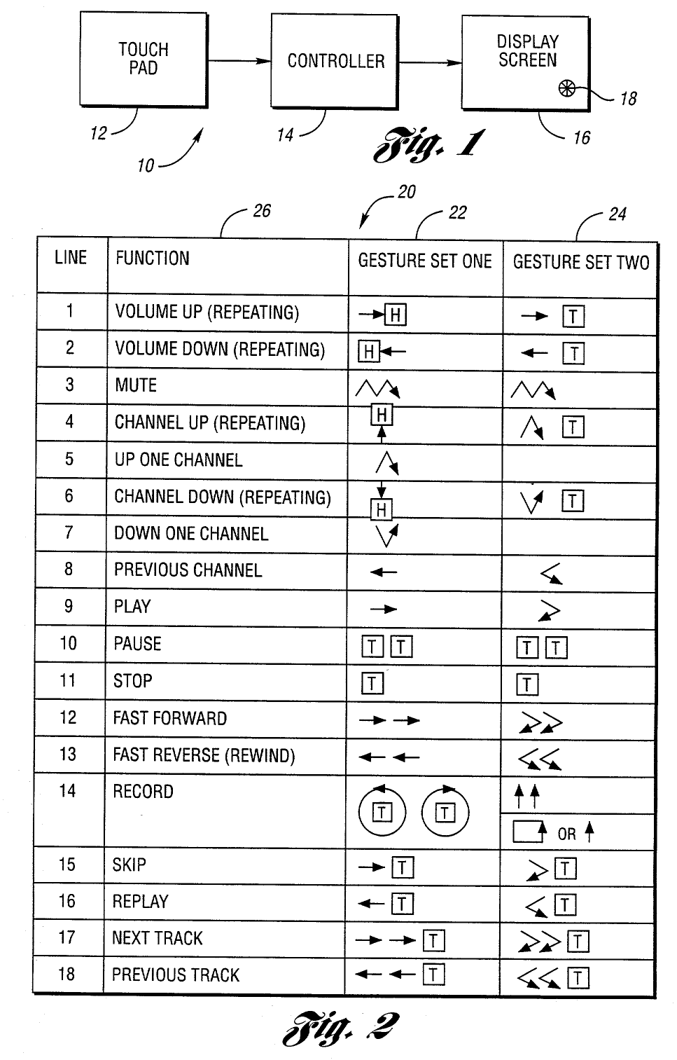

Referring now to FIG. 1, a block diagram of a remote control 10 for controlling a home entertainment device in accordance with an embodiment of the present invention is shown. Remote control 10 includes a touch pad 12, a controller 14, and a display screen 16. Touch pad 12 includes a touch pad surface area for an operator to touch. Touch pad 12 generates a signal in response to touching by an operator on the touch pad. The signal is indicative of the location of the touch on the touch pad. The signal may also be indicative of the duration and the pressure of the touch on the touch pad for each location being touched.

In an embodiment of the present invention, touch pad 12 interfaces with display screen 16 such that at least a portion of the display screen is mapped to the touch pad. Preferably, display screen 16 has a larger area than the area of touch pad 12 and the mapping is scaled as a function of the ratio of the corresponding dimensions. Each location on touch pad 12 has a corresponding location on display screen 16. Display screen 16 is preferably the display screen used by a home entertainment device such as a television screen. Display screen 16 includes a movable object 18. Display screen 16 may be separated from the home entertainment device and coupled directly to touch pad 12.

Controller 14 receives a signal from touch pad 12 in response to an operator touching the touch pad. Controller 14 moves movable object 18 on display screen 16 to the location on the display screen corresponding to the location of the touch on touch pad 12 in response to an operator touching the touch pad. Controller 14 controls the home entertainment device or on-screen game to enable a control function corresponding to the location of movable object 18 on display screen 16 in response to an operator touching touch pad 12. Controller 14 may be coupled directly or remotely located from touch pad 12. If remotely located, touch pad 12 transmits signals through means such as infrared, visible light, radio, ultrasonic, or the like to communicate with controller 14. Infrared remote operation is preferred for typical in-home applications.

In some HE or on-screen game control applications, controller 14 moves movable object 18 on display screen 16 to the location on the display screen corresponding to the location of the touch on touch pad 12 independent of the location of the movable object on the display screen prior to the touch on the touch pad. Thus, touch pad 12 is based on absolute pointing. This means that movable object 18 moves to a location on display screen 16 corresponding wherever the operator touches touch pad 12, regardless of the location of the movable object prior to the touch. That is, the touching movement of the operator on touch pad 12 is mapped absolutely on to display screen 16. Traditional pointing devices such as a computer mouse use relative pointing letting the operator move a cursor from one place to another place on a display screen. That is, the movement of the operator is mapped relative to the location from where the operator moved.

In some HE or on-screen game control applications, the operator may perform a gesture on touch pad 12. A gesture is a touch that corresponds to an understood or recognizable pattern. In response to such a gesture, the touch pad generates a gesture signal indicative of the gesture performed. Each gesture performed on touch pad 12 corresponds to an HE device or game control function. Controller 14 receives the gesture signal from the touch pad and performs the indicated control function.

In some HE or on-screen game control applications, a remote control including touch pad 12 may also have one or more buttons, switches, knobs or other input devices. These input devices may be used to perform HE control operations, provide game control, select between modes of operation, select between options, and the like. Functions of some input devices may vary based on the current application or mode of the remote control. In one embodiment, the remote control includes a trigger switch mounted on the bottom of the remote control as described in U.S. Pat. No. 5,670,988 to Tickle, issued Sep. 23, 1997, which is incorporated herein in its entirety.

Referring now to FIG. 2, a table 20 illustrating two sets of gestures 22, 24 is shown. Each gesture may include one or more strokes. A stroke on touch pad 12 constitutes all of the points crossed by an operator's finger or stylus on the touch pad while the finger or stylus is in continuous contact with the touch pad. Strokes may include touching or tapping touch pad 12. Gesture information may also include the force sensed on touch pad 12 for one or more stroke.

Gestures 22, 24 correspond to a set of home entertainment device control functions 26. Where the stroke has an X and Y displacement, the direction of the displacement is indicated in FIG. 2 by the arrowhead at the end of the stroke. A “T” enclosed in a square represents a tap on touch pad 12. An “H” enclosed in a square represents a hold on touch pad 12. Both the tap and hold do not have X and Y components. The tap and hold are differentiated from one another by time. For example, a tap is an instantaneous touch on touch pad 12 and a hold is a non-instantaneous touch on touch pad 12. Durations for tap and hold may be programmable by the user.

The Table in FIG. 2 includes a set of home entertainment device control functions 26 used to control devices such as a television and a video cassette recorder (VCR) or video disc player. For instance, a gesture may be a stroke from left to right on touch pad 12 as shown in line 9 of gesture set 22. This gesture corresponds to a control function for playing a tape or disc. Another gesture may be a stroke from right to left on touch pad 12 as shown in line 8 of gesture set 22. This gesture corresponds to a control function for changing the channel on the television to the previous channel. A gesture may be a stroke from the right to the left followed by a hold as shown in line 2 of gesture set 22. This gesture corresponds to a control function for turning up the volume of the television. A gesture may be a tap as shown in line 11 of gesture set 22. This gesture corresponds to stopping the VCR. Similarly, a gesture may be a series of taps as shown in line 10 of gesture sets 21, 22. This gesture corresponds to pausing the VCR.

In general, gestures include one or more strokes. Multi-stroke gestures are shown in FIG. 2 in the order the strokes are recognized by touch pad 12 or controller 14. Recognition of a gesture does not depend on the relative position of successive strokes on the touch pad. Of course, alternate gesture sets may be used to replace the gesture sets shown or to correspond with different home entertainment device control functions. These or similar gestures on touch pad 12 may also be used to play one or more games.

Gestures may also be alphanumeric characters traced on touch pad 12. For instance, an operator may trace “9” on touch pad 12 to change the television channel to channel “9”. The operator may also trace “M” to mute the volume of the television or trace “P” to play the VCR.

Using gestures to control home entertainment devices or to play games has many advantages. The operator has access to commands with no need to look at remote control 10. Gestures decrease the number of buttons on remote control 10. Remote control 10 can be upgraded simply by adding recognizable gestures. Hardware changes are not required, meaning that there is no need to add, subtract, or change physical buttons or legends.

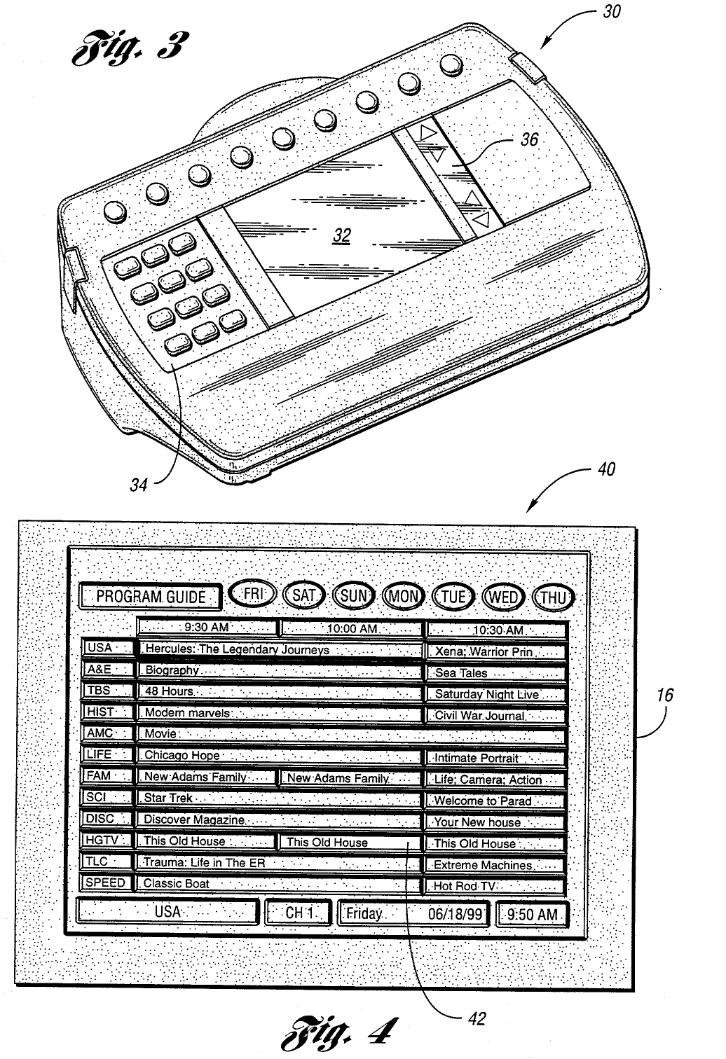

Referring now to FIG. 3, a perspective view of a remote control 30 for controlling home entertainment devices or for playing games in accordance with an embodiment of the present invention is shown. Remote control 30 includes a touch pad surface area 32, a plurality of exposed control buttons 34, and a plurality of embedded control buttons 36. Control buttons 34 and 36 are used in conjunction with touch pad 12 and are operable with controller 14 for selecting a control function for controlling a home entertainment device or on-screen game.

In general, an operator uses touch pad 12 to point or move movable object 18 to an on screen option displayed on display screen 16. The operator then uses control buttons 34 and 36 to select the option being pointed at by movable object 18 on display screen 16. Remote control 30 is useful for harmonious bimodal operation. In this mode, the operator uses one hand on touch pad 12 to point to an option on display screen 16. The operator uses the other hand to hold remote control 30 and to make a selection by actuating a control button 34, 36.

Remote control 30 may also be configured for one handed operation. In this mode, control buttons 34, 36 are not needed or may be replaced with a trigger switch. One handed operation allows the operator to keep one hand free for other purposes such as, for instance, to hold a drink while watching television or, during intense gaming, to steady remote control 30. One finger may be used on touch pad 12 to point to an option while another finger is used on touch pad 12 to select the option. Another way to select an option is to use the same finger on touch pad 12 to point to an option and then select the option. Selecting may be accomplished by lifting the finger from the touch pad, tapping the finger on the touch pad, holding the finger still on the touch pad, and the like.

Referring now to FIG. 4, an electronic program guide (EPG) 40 displayed on display screen 16 according to an embodiment of the present invention is shown. EPG 40 lists programming choices 42. EPG 40 is displayed in a grid form with television channels displayed from top to bottom with program start times from left to right. EPG 40 is mapped to touch pad 12. When EPG 40 first appears on display screen 16, the current channel is highlighted. When the operator touches touch pad 12, the directly corresponding program on display screen 16 is highlighted. For example, if the operator touches the center of touch pad 12 then the program nearest the center of display screen 16, i.e., EPG 40, becomes highlighted. If the operator touches the extreme upper left corner of touch pad 12, the upper most, left most program becomes highlighted.

If the operator slides his finger to a different area of touch pad 12, the currently highlighted program stays highlighted until the finger reaches an area of the touch pad that corresponds to a different program. The different program is then highlighted. When the operator reaches the desired program, he may use one of the selecting methods described above to select the program or perform a control function. If the operator lifts his finger from touch pad 12 and touches a different area, another directly corresponding area is highlighted.

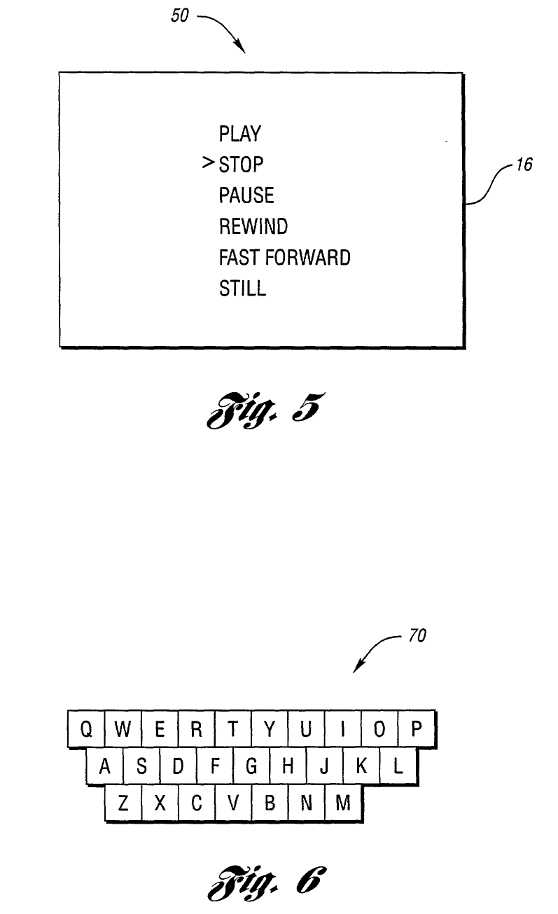

Referring now to FIG. 5, a menu 50 listing control functions or menu options for a HE device such as a VCR according to an embodiment of the present invention is shown. As shown in FIG. 5, the VCR control functions or menu options include Play, Stop, Pause, and the like. Menu 50 is mapped to touch pad 12. When an operator touches touch pad 12, the directly corresponding menu option is highlighted. For example, if the operator touches the center of touch pad 12, the menu option nearest the center of display screen 16 becomes highlighted. In general, highlighting and selecting control functions for menu 50 is performed similarly with respect to the highlighting and selecting methods associated with EPG 40. The advantages of using touch pad 12 for selecting options in menu 50 include easier and faster use than arrow keys or mouse/cursor menus, a decrease in button clutter and the ability to remotely control without looking at controller to select an option.

As will be recognized by one of ordinary skill in the art, the techniques, means and methods described for EPG control or for HE device control may be used for selecting a variety of options. For example, either may be used to present a list of on-screen games from which a desired game may be selected. Further, either may be used to set up programmable options for controller 30.

Referring now to FIG. 6, a keyboard 70 having alphanumeric keys for controlling a home entertainment device or on-screen game according to an embodiment of the present invention is shown. Keyboard 70, displayed on screen 16, is mapped to touch pad 12. When an operator touches touch pad 12, the directly corresponding keyboard key is highlighted. For example, if the operator touches the center of touch pad 12, the “G” key is highlighted. If the operator touches the upper left corner of touch pad 12, then the “Q” key is highlighted. Preferably, there are two ways to use keyboard 70. The first method is based on harmonious bimodal operation. An operator places his finger on touch pad 12 and then slides his finger until the desired key is highlighted. The operator then selects the desired key by pressing a control button 34, 36 without lifting his finger from touch pad 12. In the second method, the operator places his finger onto touch pad 12 and slides his to the area corresponding to a desired key. The operator then selects the key in one of the manners described above.

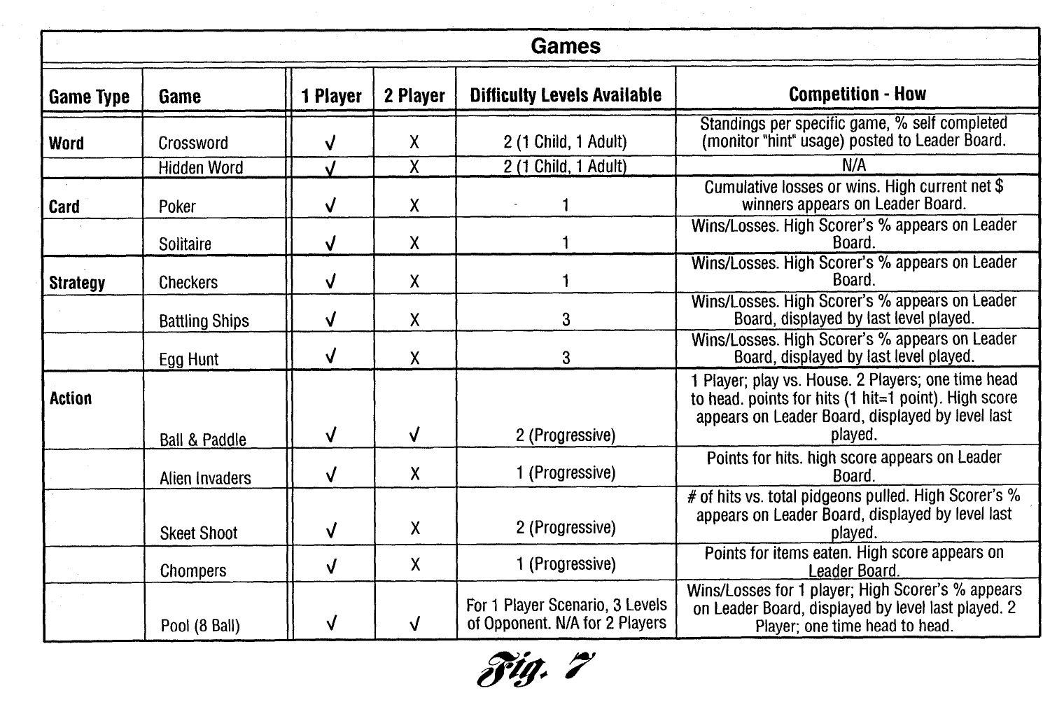

Referring now to FIG. 7, a table listing various game types according to embodiments of the present invention is shown. On-screen games may be played in a variety of manners including solitaire, in which an operator plays against one or more computer opponents; head-to-head, in which two or more local operators, each with a touch pad, play against each other; remote, in which each operator plays against human or computer players linked to controller 14 through a local network, telecommunications system, Internet, or the like; or any combination.

Typically, each game type will include one or more gestures for controlling the game. These gestures may be completely or partially programmable by one or more of a variety of techniques, such as selecting options from a menu, “teaching” controller 30 one or more desired gestures for each control option, associating a sequence of control options with a gesture, associating a set of gestures with a given game or game scenario, associating a set of gestures with a particular operator, associating a set of gestures with a particular area of touch pad 12, and the like.

Many types of gestures and other control input can be entered through touch pad 12. Particular types of control input tend to be better suited to particular types of games. One example is X and Y spatial control. Simple linear or back-and-forth movement on touch pad 12 may be used to control game activity such as ping-pong paddle placement, pool cue stroking, golf club swinging, and the like. Impact control, such as pull-back or push-forward control, can be used to implement launching a pin ball or striking a cue ball with a pool cue. The amount of force may be preset; programmable; adjustable by another control; or variably indicated by stroke length, velocity, pad pressure, or the like.

Free floating or relative two-dimensional input may be mapped to corresponding on-screen motion, such as moving a card in Solitaire or moving a character through a maze. For example, free-floating control may be used to move an on-screen gun site in a skeet shooting or asteroid blasting game.

Free floating control may also be used to position a floating object, such as a cursor, used to perform activities such as selection, marking, encircling, highlighting, and the like. For example, an on-screen pen is moved in conjunction with movement on touch pad 12. Pressing harder while moving creates an on-screen mark. Such a control may be used for maze following, drawing, game environment creation, and the like. For example, a word search game displays a pattern of letters including hidden words on screen 16. Moving a finger or stylus on touch pad 12 correspondingly moves a cursor or similar item across screen 16. Letters may be selected to indicate a found word by increasing the pressure on touch pad 12.

Pad-to-screen mapping maps the area of touch pad 12 to selectable objects displayed on the screen. A poker game example is provided in FIG. 8. Display screen 16 displays poker hand 80 and chips 82 belonging to the operator. The display may also include the amount of chips held by other “players” or caricatures representing these players. Touch pad 12 is divided into a plurality of regions corresponding to selectable items. Regions 84, 86, 88 each correspond to a stack of different valued chips. Regions 90, 92, 94, 96, 98 each correspond to a card. Region 100 corresponds to the table. When the operator moves a finger or stylus across touch pad 12, a card or chip pile corresponding to the region touched is highlighted. The card or chip may be selected as described above. Selecting table region 100 then discards one or more selected cards or bets with one or more selected chips.

Pad-to-screen mapping may also vary dynamically with the game. In the poker example, the region indicated by 102 is split into three regions, one region for each stack of chips, during periods when betting or ante is expected. Region 102 is split into five regions, one region for each card, during periods when card selection is expected.

The effect of pressure on touch pad 12 may also be used as a control input. For some games, touch pad pressure may function as a Z direction input. For example, in top-view scrolling games, pressure may be used for jumping or ducking or for changing elevation while swimming or flying. Tapping, either strength sensitive or non-sensitive, may also be used for Z input.

Rotational control may be obtained by tracing an arc, circle, spiral, or other curve on touch pad 12. Rotational control may be used in a variety of games, such as aligning a golf club or pool cue, turning a character or object, throwing, speed control, and the like.

Velocity and acceleration may also be controlled by touch pad 12. For example, a swipe and hold gesture may indicate acceleration of an on-screen object such as a racing car or a bowling ball. The desired velocity or acceleration may be indicated by swipe length, swipe direction swipe duration, swipe velocity, swipe acceleration, swipe pressure, swipe combinations, and the like. Applying point pressure to touch pad may also be used as a speed or acceleration input. For example, pressing on touch pad 12 may indicate pushing down on the accelerator or brake of an on-screen vehicle.

Alphanumeric text entry may also be obtained by tracing a letter or a gesture representing a letter on touch pad 12. Text entry is used in word games, when communicating between remote players, for entering top scores, and the like. For example, text entry may be used to enter characters in an on-screen crossword puzzle game.

Complex gestures, such as those indicated in FIG. 2, may also be used in games requiring a wide variety of control. These include first person combat games, such as boxing, martial arts, fencing, and the like, and sports games such as soccer, American football, Australian football, rugby, hockey, basketball, and the like. For example, a first person martial arts game may include three kicks with each leg, three attacks with each arm, several blocks with each side of the body, and special moves. Control programmability allows implementing a sequence of such moves with a single gesture.

An illustration of dividing a touch pad into regions having different control functions according to an embodiment of the present invention is shown in FIG. 9. Touch pad 12 may be divided into regions 110, 112 by logically partitioning the touch pad or by using two physical touch pads. Each region may interpret control input differently. For example, first person games often require controls for both heading and facing. Region 110 may control heading and movement, with vertical stroke 114 indicating forward or backward motion and horizontal stroke 116 indicating rotating heading left or right. Region 112 may control facing, with vertical stroke 118 controlling looking up or down and horizontal stroke 120 controlling looking left or right.

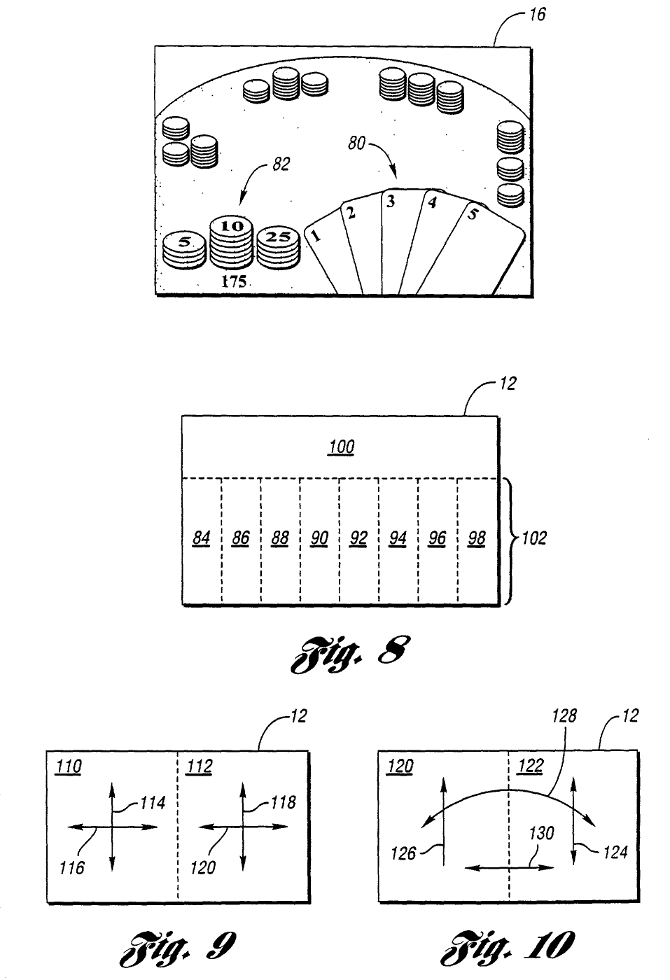

Touch pad 12 may combine both regional gestures and global gestures according to an embodiment of the present invention, as shown in FIG. 10. For example, a driving game may use vertical strokes 124 in region 122 to indicate gas pedal control and vertical strokes 126 in region 120 to indicate brake control. However, curving strokes 128 anywhere on touch pad 12 indicate steering control and horizontal strokes 130 anywhere on touch pad 12 indicate up shifting or down shifting control.

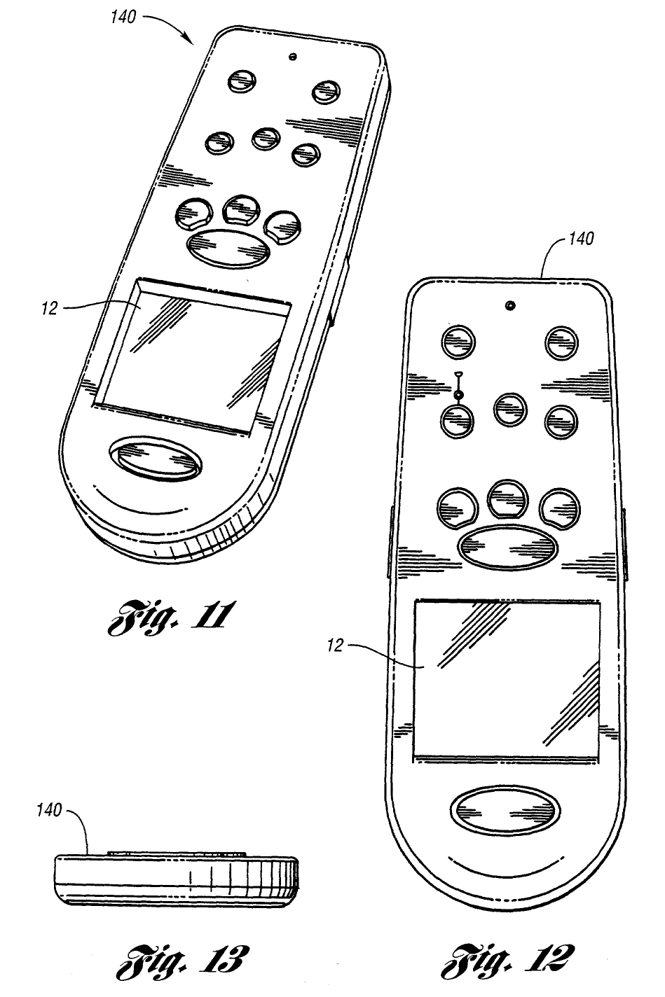

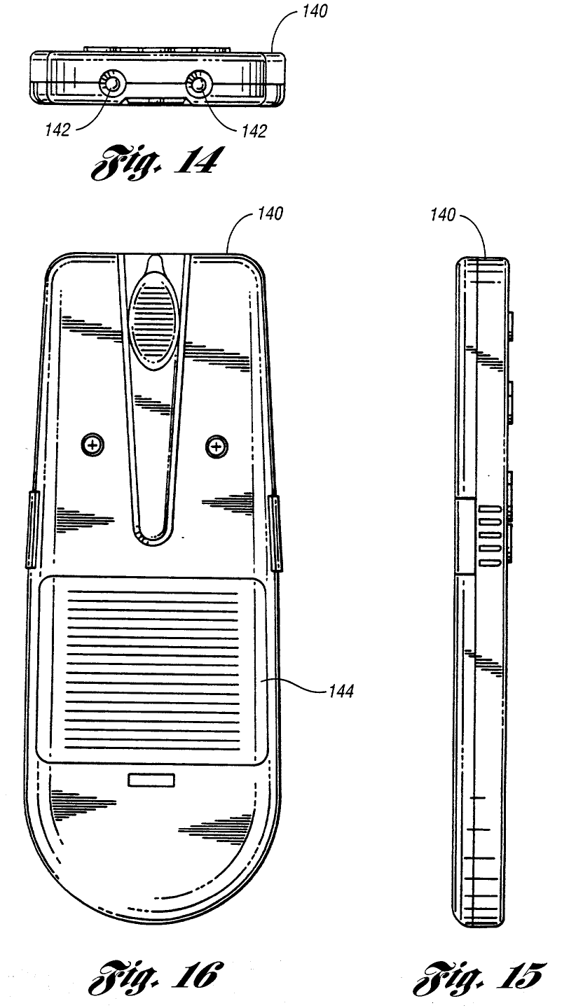

Referring now to FIGS. 11-16, views of a remote control according to an embodiment of the present invention are shown. A perspective view of remote control 140 is illustrated in FIG. 11 and a top view in FIG. 12. Both views show touch pad 12 and a plurality of buttons that may have fixed or programmable functionality. FIG. 13 is a rear view of remote control 140. FIG. 14 is a front view of remote control 140 showing infrared transmitters 142. FIG. 15 is a side view of remote control 140. FIG. 16 is a bottom view of remote control 140 showing cover 144 over a compartment holding batteries for powering remote control 140.

While embodiments of the invention have been illustrated and described, it is not intended that these embodiments illustrate and describe all possible forms of the invention. The words of the specification are words of description rather than limitation, and it is understood that various changes may be made without departing from the spirit and scope of the invention.

What is claimed is:

1. A game and home entertainment device remote control system comprising:
a remote control having a touch pad, the touch pad generating a touch pad signal in response to a gesture on the touch pad;
a display screen having a display area; and
a controller in communication with the touch pad and the display screen, the controller operative to:
receive the touch pad signal,
determine whether the touch pad signal is for controlling a game or for controlling a home entertainment device,
if the touch pad signal is for controlling a game, perform a game activity in response to the touch pad signal and cause a result of the game activity to be displayed on the display screen, and
if the touch pad signal is for controlling a home entertainment device, enable a home entertainment device control function.

2. A game and home entertainment device remote control system as in claim 1 wherein the display screen is mapped to the touch pad so that the gesture on the touch pad is scaled correspondingly to an appropriate region of the display screen.

3. A game and home entertainment device remote control system as in claim 1 wherein the display screen displays a moveable object, the controller further operative to proportionately position the moveable object on the display screen corresponding to a location touched on the touch pad.

4. A game and home entertainment device remote control system as in claim 1 wherein the touch pad is logically divided into a plurality of regions, each region corresponding to one of a plurality of selectable items displayed on the display screen.

5. A game and home entertainment device remote control system as in claim 1 wherein the touch pad is divided into a plurality of regions, the controller further operative to interpret at least one gesture in one of the plurality of regions differently than the at least one gesture is interpreted in another of the plurality of regions.

6. A game and home entertainment device remote control system as in claim 1 wherein the controller is operative to interpret at least one gesture on the touch pad based on at least one parameter programmed by a user of the system.

7. A game and home entertainment device remote control system as in claim 1 wherein the controller is further operative to adapt the operation of the touch pad to at least one operator idiosyncrasy.

8. A game and home entertainment device remote control system as in claim 1 wherein the system offers a plurality of games, the controller further operative to vary the functioning of the touch pad to fit each of the plurality of games.

9. A game and home entertainment device remote control system as in claim 1 wherein the controller is further operative to vary the functioning of the touch pad to fit each of a plurality of scenarios in at least one game.

10. A game and home entertainment device remote control system as in claim 1 wherein at least one gesture associated with at least one game may be taught to the controller by a user of the system.

11. A game and home entertainment device remote control system as in claim 1 wherein the controller is further operative to associate a sequence of game control options in at least one game with a gesture on the touch pad.

12. A game and home entertainment device remote control system as in claim 1 wherein the controller is further operative to associate at least one gesture with a particular user of the system.

13. A game and home entertainment device remote control system as in claim 1 wherein the gesture is one of a plurality of gestures comprising at least one simple linear movement.

14. A game and home entertainment device remote control system as in claim 1 wherein the gesture is one of a plurality of gestures comprising at least one free floating input.

15. A game and home entertainment device remote control system as in claim 1 wherein the gesture is one of a plurality of gestures comprising at least one gesture that is pad-to-screen mapped.

16. A game and home entertainment device remote control system as in claim 1 wherein the gesture is one of a plurality of gestures comprising at least one pressure sensitive gesture.

17. A game and home entertainment device remote control system as in claim 1 wherein the gesture is one of a plurality of gestures comprising at least one rotational control gesture.

18. A game and home entertainment device remote control system as in claim 1 wherein the gesture is one of a plurality of gestures comprising at least one velocity control gesture.

19. A game and home entertainment device remote control system as in claim 1 wherein the gesture is one of a plurality of gestures comprising at least one acceleration control gesture.

20. A game and home entertainment device remote control system as in claim 1 wherein the gesture is one of a plurality of gestures comprising at least one alphanumeric character entry gesture.

21. A game and home entertainment device remote control system as in claim 1 wherein the gesture is one of a plurality of gestures comprising at least one complex gesture, the complex gesture having at least two elements from a set consisting of straight line movements, taps, holds and circular movements.

22. A game and home entertainment device remote control system as in claim 1 wherein the touch pad is physically divided into a plurality of regions.

23. A game and home entertainment device remote control system as in claim 1 wherein the controller determines whether the touch pad signal is for controlling a game or for controlling a home entertainment device based on a signal previously received from the remote control.

24. A game and home entertainment device remote control system as in claim 1 wherein at least a portion of the display area is mapped to the touch pad.

25. A game and home entertainment device remote control system as in claim 1 wherein the remote control comprises a trigger switch.

26. A remote control for controlling a home entertainment device and for playing on-screen games in conjunction with a display screen, the remote control comprising:
a touch pad generating touch pad signals in response to user contact with the touch pad; and
a controller in communication with the touch pad, the home entertainment device and the display screen, the controller mapping at least a portion of the display screen to a surface area of the touch pad, the controller moving an object on the display screen to a location on the display screen corresponding to a touched location on the touch pad surface area for playing at least one on-screen game, the controller further recognizing gestures for controlling the home entertainment device.

27. A remote control for a home entertainment device comprising:
a touch pad generating touch pad signals in response to user contact with the touch pad; and
a controller in communication with the touch pad, the home entertainment device and the display screen, the controller mapping at least a portion of the display screen to a surface area of the touch pad, the controller moving an object on the display screen to a location on the display screen corresponding to a touched location on the touch pad surface area for playing at least one on-screen game.

28. A remote control for controlling a home entertainment device and for playing on-screen games in conjunction with a display screen, the remote control comprising:
a touch pad generating touch pad signals in response to user contact with the touch pad; and
a controller in communication with the touch pad, the home entertainment device and the display screen, the controller recognizing gestures made on the touch pad for playing at least one game and displaying results of recognizing each gesture on the display screen, the controller further recognizing gestures made on the touch pad for controlling the home entertainment device.

29. A method of remotely controlling a home entertainment device comprising:
receiving at least one gesture on a touch pad, the touch pad remote from the home entertainment device;
determining whether the at least one received gesture was made for controlling the home entertainment device or for playing a game;
if the at least one gesture was made for controlling the home entertainment device, generating at least one control signal for the home entertainment device based on the at least one received gesture; and
if the at least one gesture was made for playing a game, performing a game activity based on the at least one received gesture and displaying the results of the performed game activity on a display screen.

30. A method of remotely controlling a home entertainment device as in claim 29 wherein the touch pad is part of a remote control device.

31. A method of remotely controlling a home entertainment device as in claim 30 wherein the determination of whether the at least one received gesture was made for controlling the home entertainment device or for playing the game is based on at least one input previously received from the remote control.

32. A method of remotely controlling a home entertainment device as in claim 29 further comprising the mapping at least a portion of the display screen to the touch pad so that the at least one gesture received on the touch pad is scaled correspondingly to the at least a portion of the display screen.

33. A method of remotely controlling a home entertainment device as in claim 29 further comprising logically dividing the touch pad into a plurality of regions, each region corresponding to one of a plurality of selectable items displayed on the display screen.

34. A method of remotely controlling a home entertainment device as in claim 29 further comprising dividing the touch pad into a plurality of regions and interpreting at least one gesture in one of the plurality of regions differently than the at least one gesture is interpreted in another of the plurality of regions.

35. A method of remotely controlling a home entertainment device as in claim 29 further comprising interpreting at least one gesture on the touch pad based on at least one parameter programmed by a user of the system.

36. A method of remotely controlling a home entertainment device as in claim 29 further comprising adapting the operation of the touch pad to at least one operator idiosyncrasy.

37. A method of remotely controlling a home entertainment device as in claim 29 further comprising varying the functioning of the touch pad to fit each of a plurality of games.

38. A method of remotely controlling a home entertainment device as in claim 29 further comprising learning at least one gesture associated with the game taught by a user of the touch pad.

39. A method of remotely controlling a home entertainment device as in claim 29 further comprising associating at least one gesture with a particular user of the system.

40. A method of remotely controlling a home entertainment device as in claim 29 further comprising recognizing at least one of a plurality of gestures on the touch pad as representing simple linear movement.

41. A method of remotely controlling a home entertainment device as in claim 29 further comprising recognizing at least one of a plurality of gestures on the touch pad as representing free floating input.

42. A method of remotely controlling a home entertainment device as in claim 29 further comprising recognizing at least one of a plurality of gestures on the touch pad as representing pad-to-screen mapping.

43. A method of remotely controlling a home entertainment device as in claim 29 further comprising recognizing at least one of a plurality of gestures on the touch pad as representing a pressure sensitive gesture.

44. A method of remotely controlling a home entertainment device as in claim 29 further comprising recognizing at least one of a plurality of gestures on the touch pad as representing a rotational control gesture.

45. A method of remotely controlling a home entertainment device as in claim 29 further comprising recognizing at least one of a plurality of gestures on the touch pad as representing a velocity control gesture.

46. A method of remotely controlling a home entertainment device as in claim 29 further comprising recognizing at least one of a plurality of gestures on the touch pad as representing an acceleration control gesture.

47. A method of remotely controlling a home entertainment device as in claim 29 further comprising recognizing at least one of a plurality of gestures on the touch pad as representing an alphanumeric character entry gesture.

48. A method of remotely controlling a home entertainment device as in claim 29 further comprising recognizing at least one of a plurality of gestures on the touch pad as representing a complex gesture, the complex gesture having at least two elements from a set consisting of straight line movements, taps, holds and circular movements.
